(19) United States
(12) Patent Application Publication
(10) Pub. No.: US 2023/0234145 A1
(43) Pub. Date: Jul. 27, 2023

(54) BORING BAR AND A NON-ROTATING BORING TOOL AND A BORING ARRANGEMENT COMPRISING SUCH A BORING BAR

(71) Applicant: SECO TOOLS TOOLING SYSTEMS, Bouxwiller (FR)

(72) Inventors: Yannick GROLL, Bouxwiller (FR); Pascal KRUMHORN, Bouxwiller (FR); Mathieu OSTERMANN, Bouxwiller (FR)

(21) Appl. No.: 18/009,955

(22) PCT Filed: Jun. 9, 2021
(86) PCT No.: PCT/EP2021/065437

§ 371 Date: Dec. 12, 2022

(30) Foreign Application Priority Data
Jun. 30, 2020 (EP) 20315332.5

(51) Int. Cl. B23B 29/02

(52) U.S. Cl. CPC B23B 29/022

(57) ABSTRACT

A boring bar for a non-rotating boring tool includes an elongated body configured for attachment to a support structure of a metal cutting machine and arranged to carry a tool part provided with a cutting element. At least two electrically controlled vibration actuators are arranged for active vibration damping of the boring bar. Each actuator includes a moveably arranged damping mass configured to generate vibratory forces in parallel with a working axis of the actuator that is perpendicular to a center axis of the damping mass. Each actuator is a single-axis actuator having one single working axis, wherein the actuators are arranged with their working axes angularly offset from each other. The actuators are arranged in a longitudinal series in the elongated body with the center axis of the damping mass of each actuator coinciding with a longitudinal axis of the elongated body.

### FIELD OF THE INVENTION AND PRIOR ART

The present invention relates to a boring bar according to the preamble of claim 1. The invention also relates to a non-rotating boring tool and a boring arrangement comprising such a boring bar.

A cantilever boring bar with a cutting element at its free end may be used for performing different types of machining operations, such as for instance internal or external turning, on a rotating workpiece of metallic material. During the machining operations, the cutting element is subjected to cutting forces from the rotating workpiece, including a radial force directed along a line that extends perpendicularly to the axis of rotation of the workpiece and intersects the axis of rotation and the point of contact between the cutting element and the workpiece and a tangential force directed perpendicularly to the radial force and in the tangential direction of the workpiece surface at the point of contact between the cutting element and the workpiece. These mutually perpendicular cutting forces will induce vibrations in the boring bar, which in its turn may cause noise, impaired surface finish of the workpiece, tool breakage and other undesired effects.

Different types of active damping systems have been developed in order to reduce boring bar vibrations caused by the cutting forces on a cutting element at the outer end of a boring bar during machining of a workpiece. Such an active damping system may comprise at least one vibration sensor for sensing the vibration of the boring bar and at least one electrically controlled vibration actuator for generating vibratory forces in the boring bar, wherein the vibration actuator is controlled by an electronic control unit in dependence on measuring signals from the vibration sensor or sensors in order to introduce counter-vibrations in the boring bar that will interfere with and thereby counteract the vibrations induced in the boring bar by the cutting forces.

An active damping system of the above-mentioned type is disclosed in U.S. Pat. No. 5,170,103 A where a vibration actuator is accommodated in a cavity inside the boring bar.

An active damping system may comprise one or more vibration actuators mounted to a machine tool on the outside of the ram thereof, as disclosed in EP 3 511 112 A1, in order to damp vibrations in the ram.

### OBJECT OF THE INVENTION

The object of the present invention is to provide a boring bar of the above-mentioned type that has a new and favourable design.

### SUMMARY OF THE INVENTION

According to the invention, said object is achieved by means of a boring bar having the features defined in claim 1.

The boring bar according to the invention is configured for use in a non-rotating boring tool and comprises:
an elongated body configured for attachment to a support structure of a metal cutting machine, the elongated body having a rear end and an opposite front end, the front end being arranged to carry a tool part provided with a cutting element; and
at least two electrically controlled vibration actuators for active vibration damping of the boring bar.

Each one of said at least two actuators comprises a moveably arranged damping mass and is configured, by movement of the damping mass, to generate vibratory forces in parallel or at least substantially in parallel with a working axis of the actuator that is perpendicular to a centre axis of the damping mass, wherein each one of these at least two actuators is a single-axis actuator having one single working axis, and wherein these at least two actuators are arranged with their working axes angularly offset from each other. Furthermore, said at least two actuators are arranged in a longitudinal series in the elongated body with the centre axis of the damping mass of each one of these actuators coinciding or substantially coinciding with a longitudinal axis of the elongated body. Thus, the damping masses of the at least two actuators are arranged in the elongated body centred on the longitudinal axis of the elongated body, which will simplify the calculations used in the control of the actuators and thereby make it possible to achieve a damping system with good capability of responding to and damping vibrations in the boring bar in an accurate and quick manner.

Furthermore, with the above-mentioned arrangement of said at least two actuators, these actuators are located in the elongated body with their working axes oriented perpendicularly to the longitudinal axis of the elongated body and in mutually different directions. Hereby, the actuators in question may be optimized for counteracting vibrations in different angular directions in relation to the longitudinal axis of the boring bar, which facilitates the achievement of an efficient vibration damping. In this case, a first actuator may for instance be optimized for counteracting vibrations caused by the above-mentioned radial force on the cutting element and another actuator may be optimized for counteracting vibrations caused by the above-mentioned tangential force on the cutting element. In the latter case, it is suitable to use two actuators arranged with their working axes extending perpendicularly to each other, owing to the fact that said radial force is perpendicular to said tangential force.

In addition to two or more actuators arranged in the elongated body in the manner defined above, i.e. in addition to the above-mentioned at least two actuators, the boring bar may, if so desired, also comprise one or more additional actuators arranged in any other suitable manner.

According to an embodiment of the invention, said at least two actuators are n in number, wherein n≥2, and are so arranged in the elongated body that each one of these n actuators has its working axis oriented at an angle of 180°/n to another one of these n actuators, wherein these n actuators have their respective working axes evenly angularly distributed, and wherein the working axis of each one of these n actuators has an individual angular orientation that is different from the angular orientations of the working axes of the other ones of these n actuators. Thus, if the actuators in question are two in number they have their working axes oriented at an angle of 90° to each other, if they are three in number they have their working axes oriented at an angle of 60° to each other, and so on. Furthermore, each couple of adjacent actuators are in this case preferably arranged such that their working axes are oriented at an angle of 180°/n to each other, which implies that each one of said n actuators that is arranged next in consecutive order after a preceding one of the n actuators has its working axis oriented at an angle 180°/n to the working axis of the preceding actuator.

According to another embodiment of the invention, the elongated body comprises:
an elongated main part configured for attachment to a support structure of a metal cutting machine, the main part having a rear end and an opposite front end,
a front part having a rear end facing the front end of the main part and an opposite front end, the front end of the front part being arranged to carry said tool part, and
at least one damping module arranged between the front end of the main part and the rear end of the front part and accommodating one or more of said at least two actuators.

The above-mentioned front part of the elongated body is connected to the main part of the elongated body via the at least one damping module, wherein the at least one damping module constitutes a length section of the elongated body. Thus, the main part, the at least one damping module and the front part constitute separate and consecutively arranged length sections of the elongated body, as seen in the longitudinal direction of the elongated body. Hereby, a vibration actuator may be integrated in the elongated body of the boring bar by first mounting the actuator within a casing of an associated damping module and then securing the damping module between the main part and the front part of the elongated body, which will facilitate the assembling of the boring bar. In this case, the working direction of an actuator in relation to the point of contact between the cutting element and the workpiece may, in case of need, be adjusted by adjusting the rotary position of the associated damping module in relation to the front part of the elongated body. Furthermore, by having an actuator accommodated in a separate damping module, the damping characteristics may easily be adapted to the specific needs by modification of the damping module without having to change the other parts of the boring bar. The number of actuators in the boring bar may easily be varied in dependence on the specific needs by varying the number of damping modules arranged between the main part and the front part of the elongated body. The arrangement of an actuator in a separated damping module arranged between a main part and a front part of the elongated body also makes it easy to position the actuator close to the front end of the elongated body, which is a favourable position for the actuator due to the proximity to the cutting element where the vibrations of the boring bar are generated. Furthermore, the use of a separate damping module makes it easier to adapt this part of the boring bar to the requirements of the actuator for the purpose of maximizing the damping mass and the stroke of the actuator.

However, the elongated body of the boring bar may as an alternative lack a separate damping module of the above-mentioned type, wherein said at least two actuators are jointly accommodated in the same cavity inside the elongated body or individually accommodated in separate cavities inside the elongated body.

The at least one damping module preferably has the same cross-sectional outer peripheral shape as the main part and/or the front part. Furthermore, the main part and/or the front part and/or the at least one damping module are with advantage cylindrical, preferably circular cylindrical.

According to an embodiment of the invention, an external periphery of the main part and an external periphery of the at least one damping module are flush or substantially flush with each other. The elongated body of the boring bar may hereby be designed with a smooth outer peripheral surface.

According to another embodiment of the invention, the at least one damping module is clamped between the main part and the front part by means of tie rods, which preferably extend through passages in the at least one damping module. Hereby, the damping module or modules may be fixed between the main part and the front part of the elongated body in a simple and reliable manner. Each one of the tie rods may have a first end fixed to the main part and an opposite second end fixed to the front part.

According to another embodiment of the invention, the elongated body comprises at least two damping modules of the above-mentioned type arranged in series with each other between the front end of the main part and the rear end of the front part, wherein said at least two actuators are arranged in different ones of these damping modules. Hereby, the actuators in question may be integrated in the elongated body of the boring bar in a simple manner. As an alternative, said at least two actuators may be accommodated in one and the same damping module. The at least two damping modules are with advantage arranged to abut against each other. However, some kind of intermediate element may as an alternative be arranged between the at least two damping modules. The front part of the boring bar is preferably arranged with its rear end abutting against the front end of a foremost one of the at least two damping modules. However, some kind of intermediate element may as an alternative be arranged between the front part and the foremost damping module. A rearmost one of the at least two damping modules is preferably arranged with its rear end abutting against the front end of the main part. However, some kind of intermediate element may as an alternative be arranged between the main part and the rearmost damping module.

In order to facilitate the manufacturing of the elongated body, said at least two damping modules are with advantage of the same design and size.

Further advantageous features of the boring bar according to the present invention will appear from the description following below.

The invention also relates to a non-rotating boring tool comprising a boring bar of the above-mentioned type and a tool part provided with a cutting element, wherein this tool part is detachably attached to or integrally formed with the front end of the elongated body.

According to an embodiment of the invention, said tool part is adjustable in its rotary position in relation to the elongated body. It will hereby be possible to adjust the angular position of the cutting element in relation to the working axes of said at least two actuators in order to optimize the damping characteristics.

According to another embodiment of the invention, the cutting element comprises a rake side, a relief surface and a cutting edge formed at an intersection between the rake side and the relief surface, wherein when seen in a cross-sectional plane that is perpendicular to the longitudinal axis of the elongated body and intersects the cutting edge in a radially outermost point, a straight and imaginary reference line L intersects the cutting edge in the radially outermost point and extends in this cross-sectional plane at an angle of 6° to the relief surface on the outside of the cutting element, and wherein when seen in this cross-sectional plane, the working axis of the actuator closest to the front end of the elongated body:
forms an angle of 90°±10° to said reference line L, preferably an angle of 90°±5°, more preferably an angle of 90°±1°, or
forms an angle of 0°±10° to said reference line L, preferably an angle of 0°±5°, more preferably an angle of 0°±1°.

The relief angle of a cutting element of a non-rotating boring tool is normally 6° or close to 6°, which implies that the above-mentioned tangential force on the cutting element will be directed substantially along the reference line L defined above, whereas the above-mentioned radial force on the cutting element will be directed substantially perpendicular to this reference line L. In order to achieve an efficient vibration damping of the boring bar of a non-rotating boring tool, it is favourable to have the working axis of the actuator closest to the front end of the boring bar arranged substantially in parallel with the radial force on the cutting element so as to allow this actuator to efficiently dampen the vibrations caused by this radial force, or substantially in parallel with the tangential force on the cutting element so as to allow this actuator to efficiently dampen the vibrations caused by this tangential force. When the working axis of the actuator closest to the front end of the boring bar is arranged to form an angle of 90°±10° to the above-mentioned reference line L, this actuator will consequently be focused on damping the vibrations in the boring bar caused by the radial force on the cutting element. When the working axis of the actuator in the damping module closest to the front end of the boring bar is arranged to form an angle of 0°±10° to the above-mentioned reference line L, this actuator will instead be focused on damping the vibrations in the boring bar caused by the tangential force on the cutting element.

According to another embodiment of the invention, the boring tool comprises at least one vibration sensor mounted to the elongated body at the front end thereof or to said tool part. Hereby, the vibrations will be detected at a position close to the cutting element, which makes it possible to efficiently counteract the vibrations induced by the cutting forces acting on the cutting element.

Further advantageous features of the boring tool according to the present invention will appear from the description following below.

The invention also relates to a boring arrangement comprising a boring bar of the above-mentioned type and an electronic control unit configured to control the electric current to said at least two actuators in order to control the generation of vibratory forces in these actuators. The boring arrangement preferably also comprises at least one vibration sensor configured to generate measuring signals related to the vibration of the boring bar and to send the measuring signals to the electronic control unit, wherein the electronic control unit is configured to receive the measuring signals from the at least one vibration sensor and control the electric current to said at least two actuators in dependence on the measuring signals from the at least one vibration sensor in order to control the generation of vibratory forces in these actuators in dependence on these measuring signals.

Further advantageous features of the boring arrangement according to the present invention will appear from the description following below.

### BRIEF DESCRIPTION OF THE DRAWINGS

With reference to the appended drawings, a specific description of embodiments of the invention cited as examples follows below. In the drawings:

FIG. 1 is a lateral view of a non-rotating boring tool according to an embodiment of the present invention,

FIG. 2 is a longitudinal section according to the line II-II in FIG. 1,

FIG. 3 is an exploded view of the boring tool of FIG. 1,

FIG. 4 is an exploded view from another direction of the boring tool of FIG. 1,

FIG. 5 is a perspective view of a front end of the boring tool of

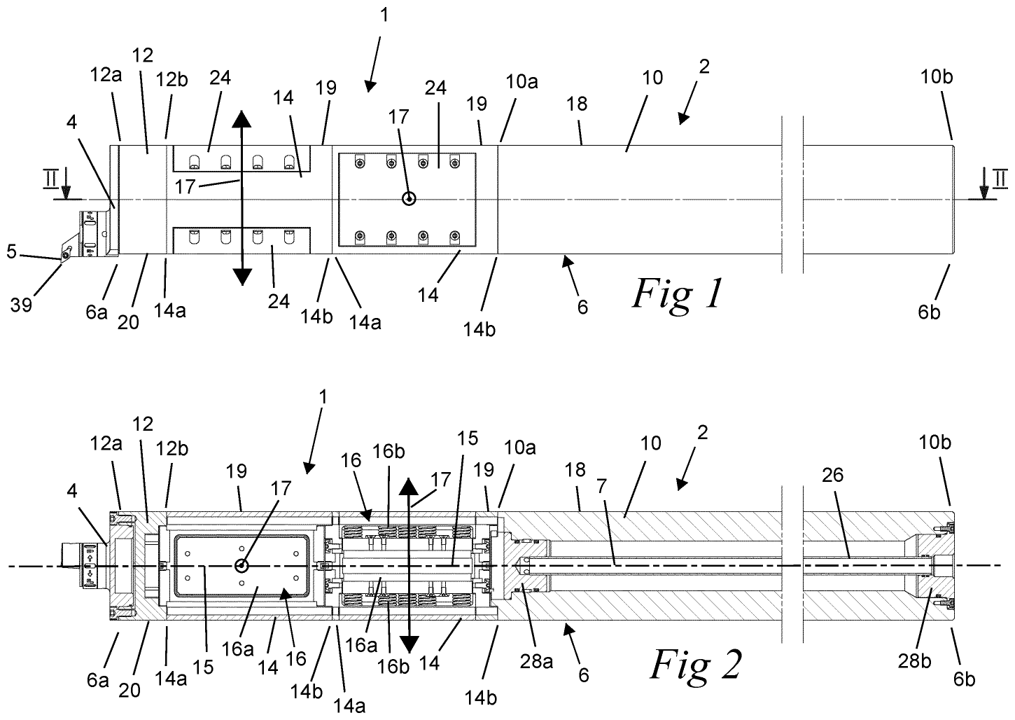

FIG. 1,

FIGS. 6a and 6b are front views of the boring tool of FIG. 1,

FIG. 7a is a perspective view from above of a cutting element included in the boring tool of FIG. 1,

FIG. 7b is a perspective view from below of the cutting element of FIG. 7a,

FIG. 7c is a lateral view of the cutting element of FIG. 7a,

FIG. 8a is a perspective view from above of an alternative cutting element,

FIG. 8b is a perspective view from below of the cutting element of FIG. 8a,

FIG. 8c is a lateral view of the cutting element of FIG. 8a,

FIG. 9 is an outline diagram of a boring arrangement according to an embodiment of the invention,

FIG. 10 is an outline diagram of a boring arrangement according to an alternative embodiment of the invention, and

FIG. 11 is an outline diagram of a boring arrangement according to another alternative embodiment of the invention.

### DETAILED DESCRIPTION OF EMBODIMENTS OF THE INVENTION

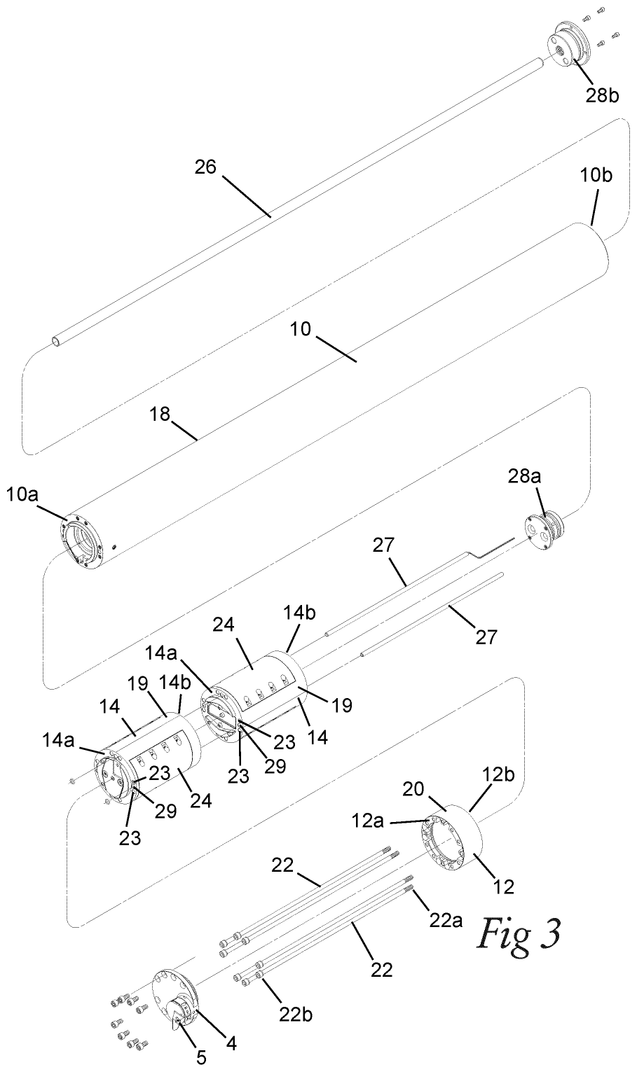

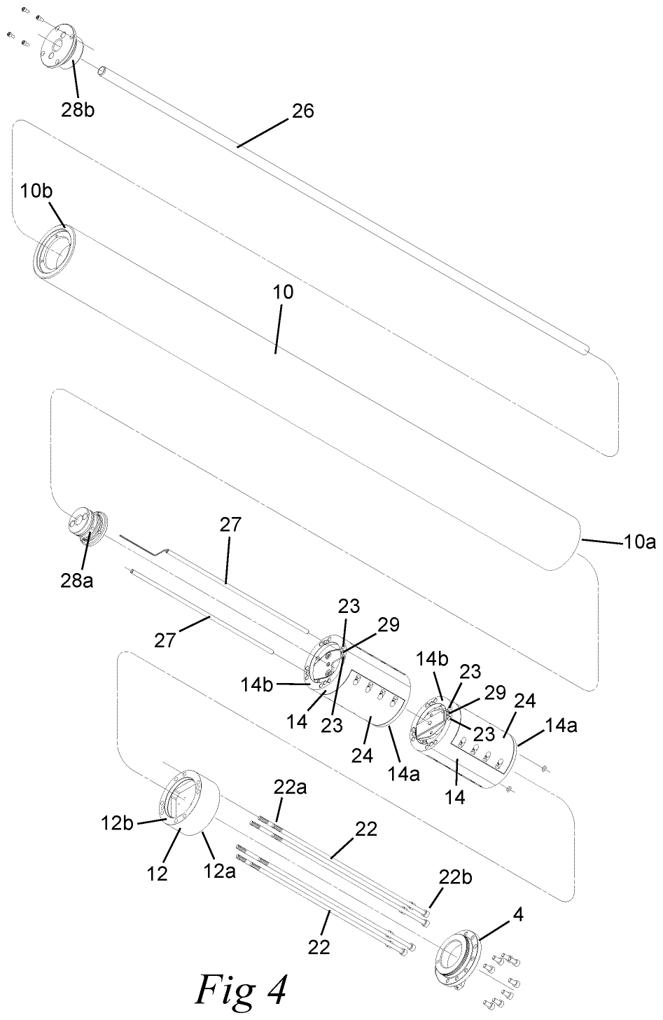

A non-rotating boring tool 1 according to an embodiment of the present invention is illustrated in FIGS. 1-5. The boring tool 1 is to be used for performing different types of machining operations, such as for instance internal or external turning, on a rotating workpiece of metallic material. The boring tool 1 comprises a boring bar 2, which is to be fixed to a support structure 3 of a metal cutting machine (very schematically illustrated in FIGS. 9-11) in order to project in a cantilevered manner from this support structure 3. The boring bar 2 comprises an elongated body 6 configured for attachment to the support structure 3 of the metal cutting machine. The elongated body 6 has a rear end 6b and an opposite front end 6a. A longitudinal axis 7 of the elongated body extends between the rear end 6b and the front end 6a of the elongated body.

The boring tool 1 also comprises a tool part 4 provided with a cutting element 5, wherein this tool part 4 is carried by the elongated body 6 and mounted to the elongated body at the front end 6a thereof. As an alternative, the tool part 4 may be integrally formed with the front end 6a of the elongated body, which implies that the tool part 4 and the elongated body 6 are combined into a common component.

The boring bar 2 comprises at least two electrically controlled vibration actuators 16 for active vibration damping of the boring bar 2. Each one of these actuators 16 comprises a moveably arranged damping mass 16a and is configured, by movement of its damping mass, to generate vibratory forces in parallel or at least substantially in parallel with a working axis 17 of the actuator that is perpendicular to a centre axis 15 of the damping mass 16a. Each one of the at least two actuators 16 is a single-axis actuator having one single working axis 17 and these actuators 16 are arranged with their working axes 17 angularly offset from each other. Thus, the actuators 16 are arranged in mutually different rotary positions in the elongated body 6.

Said actuators 16 are configured to generate vibratory forces in order to counteract vibrations induced in the boring bar 2 by cutting forces acting on the cutting element 5 during machining of a rotating workpiece. The vibratory forces generated by the actuators 16 may also be used for intermittently vibrating the cutting element 5 in order to break to pieces larger metal chips cut off from a workpiece by the cutting element 5.

Said actuators 16 are arranged in a longitudinal series in the elongated body 6, i.e. arranged consecutively in the longitudinal direction of the elongated body, with the centre axis 15 of the damping mass 16a of each one of these actuators 16 coinciding or at least substantially coinciding with the longitudinal axis 7 of the elongated body 6. Thus, the working axis 17 of each one of the actuators 16 extends in a cross-sectional plane that is perpendicular to the longitudinal axis 7 of the elongated body 6.

In the embodiment illustrated in FIGS. 1-5, said actuators 16 are two in number, but the boring bar 2 may as an alternative comprise more than two such actuators 16 arranged in the elongated body 6 such that the working axes 17 of all these actuators are preferably oriented in mutually different directions. The working axes 17 of these actuators 16 are preferably evenly angularly distributed, wherein each one of these actuators 16 has its working axis 17 oriented at an angle of 180°/n to another one of the actuators, where n is an integer corresponding to the number of actuators 16. Thus, when said actuators 16 are two in number they are preferably so arranged in the elongated body 6 that they have their working axes 17 oriented at an angle of 90° to each other, i.e. perpendicular to each other, as illustrated in FIGS. 1 and 2. When said actuators 16 are three in number they are preferably so arranged in the elongated body 6 that they have their working axes 17 oriented at an angle of 60° to each other, when they are four in number they are preferably so arranged in the elongated body 6 that they have their working axes 17 oriented at an angle of 45° to each other, and so on. Furthermore, the actuators 16 in each couple of adjacent actuators are in this case preferably arranged such that their working axes are oriented at an angle of 180°/n to each other.

In the embodiment illustrated in FIGS. 1-5, the elongated body 6 of the boring bar 2 is made up of separate parts 10, 12, 14, which are connected to each other and together form the elongated body 6, wherein these parts 10, 12, 14 constitute separate length sections, i.e. separate segments, of the elongated body 6. Thus, these parts 10, 12, 14 constitute consecutive sections of the elongated body 6 of the boring bar, as seen in the longitudinal direction thereof. In this case, the elongated body 6 comprises an elongated main part 10 configured for attachment to the support structure 3 of the metal cutting machine. This main part 10 has a rear end 10b and an opposite front end 10a. The main part 10 is preferably tubular and it is to be attached to said support structure 3 at its rear end 10b. In the illustrated embodiment, the main part 10 is cylindrical and has a circular cross-sectional shape. However, the main part 10 may also have any other suitable cross-sectional shape, such as for instance an elliptical or a polygonal cross-sectional shape.

The elongated body 6 illustrated in FIGS. 1-5 further comprises a front part 12. This front part 12 has a rear end 12b facing the front end 10a of the main part 10 and an opposite front end 12a. The front end 12a of the front part is arranged to carry the above-mentioned tool part 4. Thus, this tool part 4 is attached to the front part 12 of the boring bar at the front end 12a thereof. As an alternative, the tool part 4 may be integrally formed with the front part 12, which implies that the tool part 4 and the front part 12 are combined into a common component. In the illustrated embodiment, the front part 12 is cylindrical and has a circular cross-sectional shape. However, the front part 12 may also have any other suitable cross-sectional shape, such as for instance an elliptical or a polygonal cross-sectional shape.

The elongated body 6 may also comprise at least one damping module 14 arranged between the front end 10a of the main part 10 and the rear end 12b of the front part 12, wherein this damping module 14 has a rear end 14b facing the main part 10, an opposite front end 14a facing the front part 12. In the illustrated embodiment, the elongated body 6 comprises two such damping modules 14 arranged in series with each other between the front end 10a of the main part 10 and the rear end 12b of the front part 12. Thus, these two damping modules 14 are arranged in series with each other in the longitudinal direction of the elongated body 6. The elongated body 6 may as an alternative comprise more than two damping modules 14 arranged in series with each other in the longitudinal direction of the elongated body or one single damping module 14. The front part 12 is connected to the main part 10 via the damping modules 14.

In the illustrated embodiment, the damping modules 14 are cylindrical and have a circular cross-sectional shape. However, the damping modules 14 may also have any other suitable cross-sectional shape, such as for instance an elliptical or a polygonal cross-sectional shape.

Each one of the damping modules 14 is provided with at least one of the above-mentioned actuators 16, wherein this actuator 16 is arranged in a housing 14c of the associated damping module, the damping mass 16a of the actuator 16 being moveable in relation to this housing 14c. In the illustrated embodiment, the damping mass 16a is moveable in relation to the housing 14c of the damping module 14 against the action of return springs 16b arranged on opposite sides of the damping mass 16a. The actuators 16 may be of electromagnetic type, wherein the vibratory forces are electromagnetically generated. However, any other suitable type of vibration actuators may also be used.

In the illustrated embodiment, each damping module 14 is provided with one single actuator 16. However, an individual damping module 14 may as an alternative be provided with two or more actuators 16.

In the illustrated embodiment, the damping modules 14 abut directly against each other, wherein the rear end 14b of a foremost one of the damping modules abuts against the front end 14a of the other damping module, i.e. the rearmost damping module. As illustrated in FIGS. 1-5, the front part 12 may be arranged with its rear end 12b abutting directly against the front end 14a of the foremost damping module and the rearmost damping module may be arranged with its rear end 14b abutting directly against the front end 10a of the main part 10.

An external periphery 18 of the main part 10 and an external periphery 19 of each damping module 14 are with advantage flush or substantially flush with each other, as illustrated in FIGS. 1, 2 and 5. Furthermore, an external periphery 20 of the front part 12 is with advantage flush or substantially flush with the external periphery 19 of the foremost damping module 14.

In order to facilitate maintenance and repair of the boring bar 2, the main part 10, the damping modules 14 and the front part 12 are preferably detachably mounted to each other. In the illustrated embodiment, the damping modules 14 are clamped between the main part 10 and the front part 12 by means of tie rods 22. Each tie rod 22 has a first end 22a fixed to the main part 10 and an opposite second end 22b fixed to the front part 12. Furthermore, each tie rod 22 extends through mutually aligned passages 23 in the damping modules 14. The different parts 10, 12, 14 of the elongated body 6 may as an alternative be mounted to each other in any other suitable manner.

In the illustrated embodiment, the actuator 16 in each one of the damping modules 14 is accessible through two openings on opposite sides of the damping module, wherein each opening is covered by a detachably mounted cover 24, which forms part of the external periphery 19 of the damping module and which is secured in the associated opening by means of fastening elements 25 in the form of screws. Passages 23 for some of the above-mentioned tie rods 22 may be provided in the covers 24.

In the illustrated embodiment, cooling fluid is supplied to the tool part 4 through a first feed pipe 26, which extends axially through the main part 10 of the elongated body 6, and at least one second feed pipe 27, which extends between the main part 10 and the front part 12 of the elongated body in parallel with the tie rods 22. In the illustrated example, the boring bar 2 is provided with two such second feed pipes 27. The first feed pipe 26 is fixed to the main part 10 of the elongated body by means of a first end piece 28a fixed to the main part 10 at the front end 10a thereof and a second end piece 28b fixed to the main part 10 at the rear end 10b thereof. Each one of the second feed pipes 27 is connected to the first feed pipe 26 via internal channels in the first end piece 28a. Furthermore, each one of the second feed pipes 27 may be arranged to extend through mutually aligned passages 29 in the damping modules 14.

In order to make possible an adjustment of the angular position of the working axes 17 of the actuators 16 in relation to the cutting element 5, the front part 12 of the elongated body 6 may be adjustable in its rotary position in relation to the damping modules 14, which implies that the front part 12 is attachable to the foremost damping module 14 in different selectable rotary positions in relation to this damping module. As an alternative to or in combination with such a rotary adjustability of the front part 12 in relation to the damping modules 14, the tool part 4 provided with the cutting element 5 may be adjustable in its rotary position in relation to the front part 12 of the elongated body, which implies that the tool part 4 is attachable to the front part 12 in different selectable rotary positions in relation to the front part. A damping module 14 may also be arranged such that its actuator 16 may be adjustable in its rotary position in relation to a casing of the damping module. When the damping modules 14 are two or more in number, they may be arranged such that their respective rotary positions may be adjustable in relation to each other.

The cutting element 5 fixed to the tool part 4 may be a positive cutting element, as illustrated in FIGS. 7a-7c, or a negative cutting element, as illustrated in FIGS. 8a-8c. The cutting element 5 comprises an upper rake side 30, a bottom side 31 extending in parallel or substantially in parallel with the rake side 30 and a peripheral relief surface 32 extending between the rake side 30 and the bottom side 31. A cutting edge 33 is formed at an intersection between the rake side 30 and the relief surface 32. In the illustrated examples, the cutting edge 33 extends all around the rake side 30 along the periphery thereof. In case of a positive cutting element 5, the relief surface 32 extends at an acute angle α to the rake side 30, as illustrated in FIG. 7c. In case of a negative cutting element 5, the relief surface 32 extends at a right angle to the rake side 30, as illustrated in FIG. 8c.

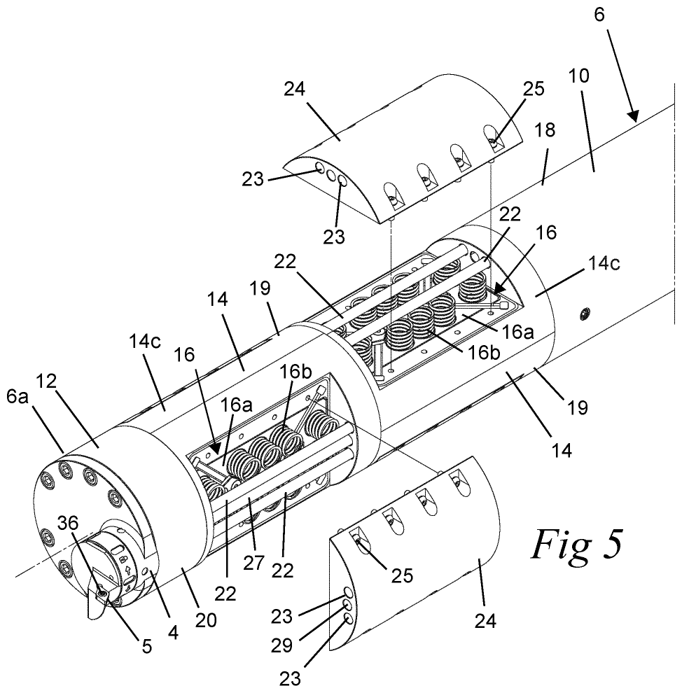

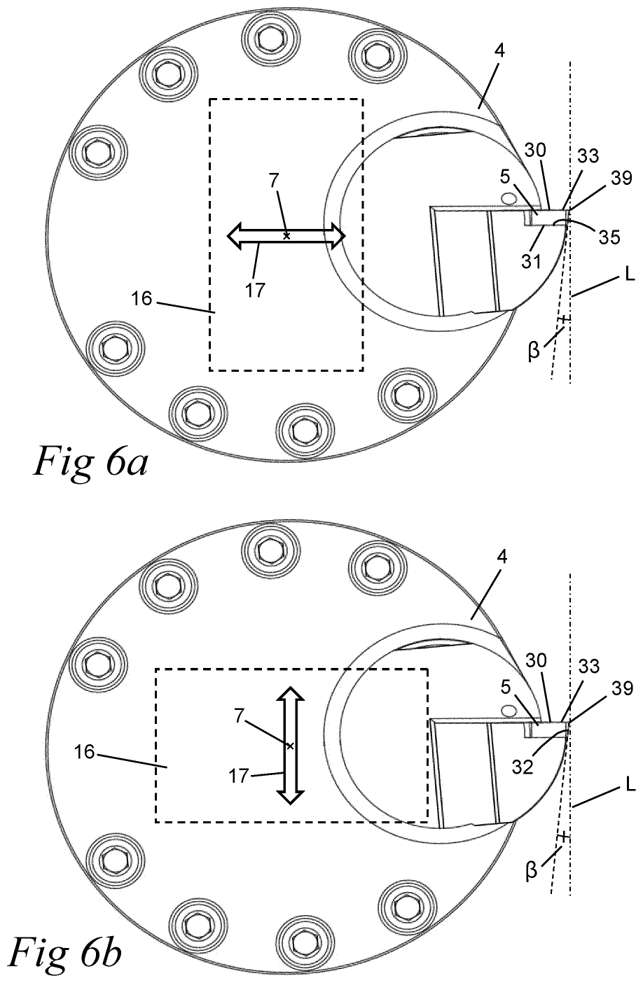

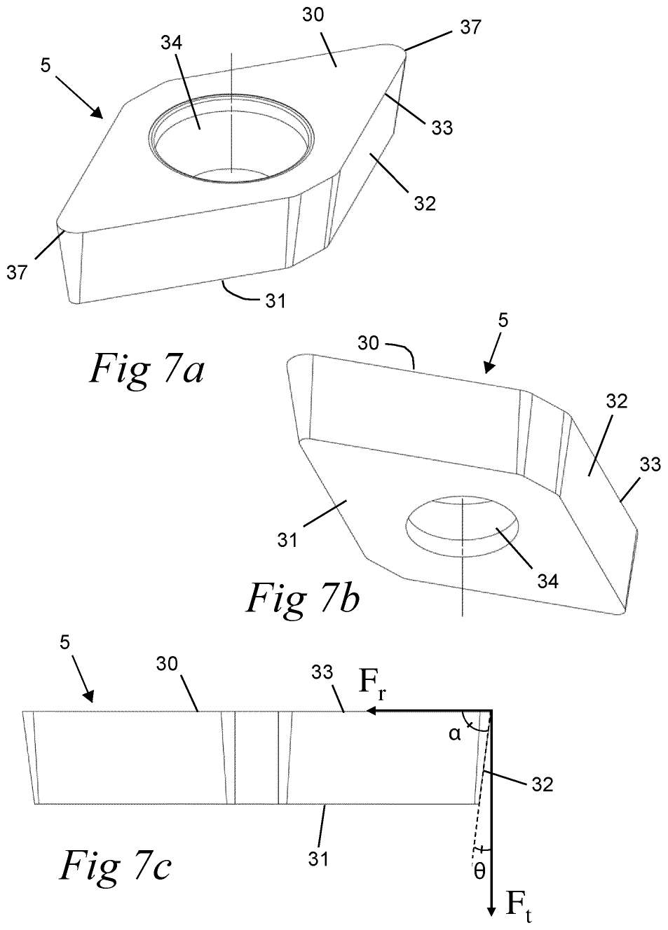

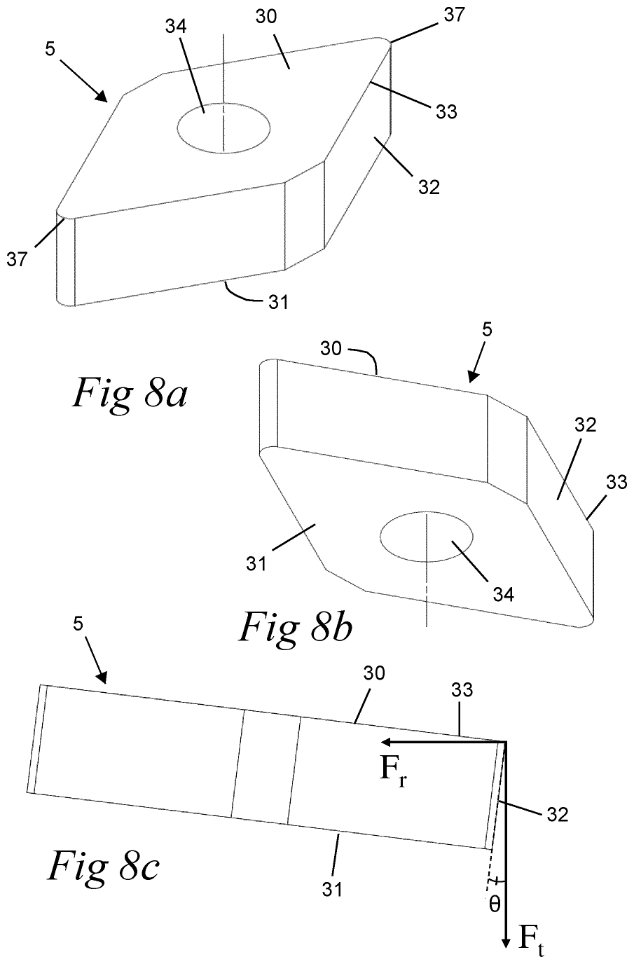

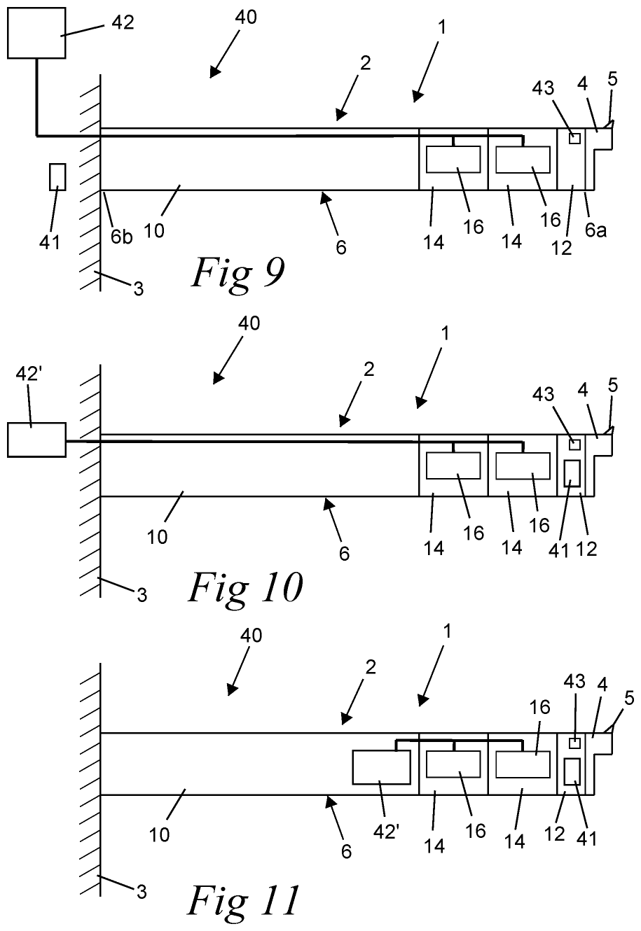

A hole 34 extends across the cutting element 5 between the rake side 30 and the bottom side 31. The cutting element 5 is configured to be releasably mounted to the tool part 4 with the bottom side 31 of the cutting element 5 resting against a support surface 35 (see FIG. 6a) on a seat provided for the cutting element in the tool part 4. The cutting element 5 is fixed to said seat in the tool part 4 by means of a fastening element 36 in the form of a screw (see FIG. 5), which extends through the hole 34 in the cutting element 5 and is engaged in a threaded hole in the support surface 35 on the seat.

In the illustrated examples, the cutting element 5 comprises two cutting corners 37 located opposite each other on opposite sides of the cutting element. The cutting element 5 is to be fixed to the tool part 4 with one of the cutting corners 37 facing outwards away from the longitudinal axis 7 of the boring bar 2, wherein the cutting element 5 is intended to make contact with a rotating workpiece via this outwardly facing cutting corner 37. During machining of a rotating workpiece, the boring tool 1 is normally so positioned in relation to the workpiece that the above-mentioned tangential force Fₜ on the cutting element 5 will be directed at an angle θ of approximately 6° to the relief surface 32, as illustrated in FIGS. 7c and 8c.

A straight and imaginary reference line L (see FIGS. 6a and 6b) is defined in a cross-sectional plane that is perpendicular to the longitudinal axis 7 of the elongated body 6 and that intersects the cutting edge 33 in a radially outermost point 39, wherein this reference line L intersects the cutting edge 33 in the radially outermost point 39 and extends in this cross-sectional plane at an angle β of 6° to the relief surface 32 on the outside of the cutting element 5, i.e. with this angle β measured on the outside of the cutting element 5. Thus, when a positive cutting element 5 of the type illustrated in FIGS. 7a-7c with a relief angle of 6° is fixed to the tool part 4, the reference line L may extend perpendicularly to the rake side 30 of the cutting element, as illustrated in FIGS. 6a and 6b.

The actuator 16 closest to the front end 6a of the elongated body 6 is with advantage arranged in such a rotary position in the elongated body 6 that its working axis 17, when seen in the above-mentioned cross-sectional plane, forms an angle of 90°±10° to said reference line L (as illustrated in FIG. 6a), preferably an angle of 90°±5°, and more preferably an angle of 90°±1°. In this case, the working axis 17 of this actuator is arranged substantially in parallel with the radial force Fᵣ on the cutting element 5. With such an arrangement of the actuator 16 closest to the front end 6a of the elongated body, this actuator will be optimized for counteracting the vibrations caused by the radial force Fᵣ on the cutting element 5.

According to a favourable alternative, the actuator 16 closest to the front end 6a of the elongated body 6 is arranged in such a rotary position in the elongated body 6 that its working axis 17, when seen in the above-mentioned cross-sectional plane, forms an angle of 0°±10° to said reference line L (as illustrated in FIG. 6b), preferably an angle of 0°±5°, and more preferably an angle of 0°±1°. In this case, the working axis 17 of this actuator is arranged substantially in parallel with the tangential force Fₜ on the cutting element 5. With such an arrangement of the actuator 16 closest to the front end 6a of the elongated body, this actuator will be optimized for counteracting the vibrations caused by the tangential force Fₜ on the cutting element 5.

Different embodiments of a boring arrangement 40 comprising a boring bar 2 of the type described above are very schematically illustrated in FIGS. 9-11. The boring arrangement 40 further comprises an electronic control unit 41, which is configured to control the supply of electric current to the actuators 16 in the elongated body 6 in order to control the generation of vibratory forces in these actuators. The electric current is supplied to the actuators 16 from a power source, which may be an external power source 42, as illustrated in FIG. 9, or a power supply unit 42′ mounted to the elongated body 6, as illustrated in FIG. 11, or to the support structure 3 or any other part of the metal cutting machine, as illustrated in FIG. 10. The power supply unit 42′ comprises at least one energy storage member, for instance in the form of a battery, for storing electric energy. The electronic control unit 41 may be mounted to the front part 12 of the elongated body 6, as illustrated in FIGS. 10 and 11, or to any other part of the elongated body. As a further alternative, the electronic control unit 41 may be mounted to the support structure 3 or any other part of the metal cutting machine, as illustrated in FIG. 9.

The boring arrangement 40 further comprises at least one vibration sensor 43, for instance in the form of an accelerometer, which is configured to generate measuring signals related to the vibration of the boring bar 2 and to send the measuring signals to the electronic control unit 41 through a wireless connection or a cable connection. Said at least one vibration sensor 43 is preferably mounted to the front part 12 of the elongated body 6 or to the tool part 4, but it may as an alternative be mounted to any other suitable part of the elongated body 6.

The electronic control unit 41 is configured to receive the measuring signals from the at least one vibration sensor 43 and to control the supply of electric current to the actuators 16 in dependence on these measuring signals in order to control the generation of vibratory forces in each actuator 16 in dependence on these measuring signals and thereby counteract the vibrations induced in the boring bar 2 by the cutting forces Fᵣ, Fₜ acting on the cutting element 5 during machining of a workpiece.

The invention is of course not in any way restricted to the embodiments described above. On the contrary, many possibilities to modifications thereof will be apparent to a person with ordinary skill in the art without departing from the basic idea of the invention such as defined in the appended claims. In some applications, damping in the direction of the radial cutting force requires twice as much energy as in the tangential direction. Thus, the boring bar may comprise three damping actuators, wherein two of them have their respective working axis oriented in the same way, preferably perpendicular to said reference line L, i.e. oriented in the direction of the radial cutting force, and the third one may have its working axis oriented in parallel to the reference line L and perpendicular to the working axis of the other two actuators.

1. A boring bar for a non-rotating boring tool, the boring bar comprising:
an elongated body configured for attachment to a support structure of a metal cutting machine, the elongated body having a rear end and an opposite front end, the front end being arranged to carry a tool part provided with a cutting element; and
at least two electrically controlled vibration actuators for active vibration damping of the boring bar, each of the at least two actuators including a moveably arranged damping mass and being configured, by movement of the damping mass, to generate vibratory forces in parallel or at least substantially in parallel with a working axis of the actuator that is perpendicular to a centre axis of the damping mass, wherein each of the at least two actuators is a single-axis actuator having one single working axis, and wherein the at least two actuators are arranged with their working axes angularly offset from each other, wherein the at least two actuators are arranged in a longitudinal series in the elongated body with the centre axis of the damping mass of each one of these actuators coinciding or substantially coinciding with a longitudinal axis of the elongated body.

2. The boring bar according to claim 1, wherein said at least two actuators are n in number, wherein n≥2, and are so arranged in the elongated body that each of the n actuators has its working axis oriented at an angle of 180°/n to another one of these n actuators, wherein the n actuators have their respective working axes evenly angularly distributed, and wherein the working axis of each one of these n actuators has an individual angular orientation that is different from the angular orientations of the working axes of the other ones of the n actuators.

3. The boring bar according to claim 2, wherein each couple of adjacent actuators are arranged such that their working axes are oriented at an angle of 180°/n to each other.

4. The boring bar according to claim 1, wherein the elongated body includes an elongated main part configured for attachment to a support structure of a metal cutting machine, the main part having a rear end and an opposite front end, a front part having a rear end facing the front end of the main part and an opposite front end, the front end (12a) of the front part being arranged to carry said tool part, and at least one damping module arranged between the front end (10a) of the main part and the rear end of the front part and accommodating one or more of said at least two actuators, and wherein the front part of the elongated body is connected to the main part thereof via the at least one damping module, wherein the at least one damping module constitutes a length section of the elongated body.

5. The boring bar according to claim 4, wherein the at least one damping module has the same cross-sectional outer peripheral shape as the main part and/or the front part.

6. The boring bar according to claim 4, wherein the main part and/or the front part and/or the at least one damping module are cylindrical.

7. The boring bar according to claim 4, wherein an external periphery of the main part and an external periphery of the at least one damping module are flush or substantially flush with each other.

8. The boring bar according to claim 4, wherein the at least one damping module is clamped between the main part and the front part by means of tie rods, which preferably extend through passages in the at least one damping module.

9. The boring bar according to claim 4, wherein the front part of the elongated body is adjustable in its rotary position in relation to the at least one damping module.

10. The boring bar according to claim 4, wherein said at least two actuators are accommodated in the same damping module.

11. The boring bar according to claim 4, wherein the elongated body includes at least two damping modules arranged in series with each other between the front end of the main part and the rear end of the front part, wherein said at least two actuators are arranged in different ones of these damping modules.

12. A non-rotating boring tool comprising:
a boring bar according to claim 1; and
a tool part provided with a cutting element, wherein the tool part is detachably attached to or integrally formed with the front end of the elongated body.

13. The non-rotating boring tool according to claim 12, wherein the tool part is adjustable in its rotary position in relation to the elongated body.

14. The non-rotating boring tool according to claim 12, wherein the cutting element includes a rake side, a relief surface and a cutting edge formed at an intersection between the rake side and the relief surface, wherein when seen in a cross-sectional plane that is perpendicular to the longitudinal axis of the elongated body and intersects the cutting edge in a radially outermost point, a straight and imaginary reference line intersects the cutting edge in the radially outermost point and extends in this cross-sectional plane at an angle (β) of 6° to the relief surface on the outside of the cutting element, and wherein when seen in this cross-sectional plane, the working axis of the actuator closest to the front end of the elongated body forms an angle of 90°±10° to said reference line L or forms an angle of 0°±10° to said reference line L.

15. The non-rotating boring tool according to claim 12, further comprising at least one vibration sensor mounted to the elongated body at the front end thereof or to said tool part.

16. A boring arrangement comprising:
a boring bar according to claim 1; and
an electronic control unit configured to control the electric current to said at least two actuators in order to control the generation of vibratory forces in the actuators.

17. The boring arrangement according to claim 16, further comprising at least one vibration sensor configured to generate measuring signals related to the vibration of the boring bar and to send the measuring signals to the electronic control unit, wherein
the electronic control unit is configured to receive the measuring signals from the at least one vibration sensor, and wherein the electronic control unit is configured to control the electric current to said at least two actuators in dependence on the measuring signals from the at least one vibration sensor in order to control the generation of vibratory forces in these actuators in dependence on these measuring signals.
